(19) United States
(12) Patent Application Publication
(10) Pub. No.: US 2026/0067128 A1
(43) Pub. Date: Mar. 5, 2026

(54) IN-VEHICLE NETWORK SYSTEM AND CONTROL METHOD

(71) Applicant: DENSO CORPORATION, Kariya-city (JP)

(72) Inventors: SHO MATSUMOTO, Kariya-city (JP); TOMOHISA KISHIGAMI, Kariya-city (JP)

(21) Appl. No.: 19/283,483

(22) Filed: Jul. 29, 2025

(30) Foreign Application Priority Data
Sep. 5, 2024 (JP) 2024-153409

(51) Int. Cl. H04L 12/40; B60R 16/023; H02J 3/00

(52) U.S. Cl. CPC H04L 12/40039; B60R 16/023; H02J 3/001; H04L 12/4013; H02J 2105/30; H04L 2012/40273

(57) ABSTRACT

An in-vehicle network system includes a plurality of control devices connected to a communication bus and configured to communicate with each other. The plurality of control devices includes at least one upper control device and a plurality of lower control devices. The upper control device turns on and off a plurality of relay circuits provided in a power supply line, receives a network management message, instructs the power management unit to turn on the relay circuit, sets the lower control device, detects a power supply state and a communication state, and determines an abnormality occurrence location.

### CROSS REFERENCE TO RELATED APPLICATION

This application is based on Japanese Patent Application No. 2024-153409 filed on September 5, 2024, the disclosure of which is incorporated herein by reference.

### TECHNICAL FIELD

The present disclosure relates to an in-vehicle network system that includes multiple control devices capable of mutual communication, connected via a communication bus, and a control method for the in-vehicle network system.

### BACKGROUND

A related art discloses an in-vehicle network system including an upper control device, an intermediate control device, and a lower control device. In the in-vehicle network system, the intermediate control device receives power from a power supply and supplies power from the power supply to the lower control device in response to a message received from the upper control device. In other words, the intermediate control device maintains the lower control device in a power-off state until a message is received from the upper control device. Upon receiving a message from the upper control device at the intermediate control device, power is supplied to the lower control device. The lower control device transitions from the power-off state to a standby state, awaiting instructions, due to this power supply.

### SUMMARY

According to an aspect of the present disclosure, an in-vehicle network system may include a plurality of control devices connected to a communication bus and configured to communicate with each other in a vehicle. The plurality of control devices may include at least one upper control device and a plurality of lower control devices. The at least one upper control device may include a power management unit configured to turn on and off a plurality of relay circuits provided in a power supply line of each of the plurality of the lower control devices, a startup management unit configured to receive a network management message on behalf of a plurality of the lower control devices, to instruct the power management unit to turn on the relay circuit provided in the power supply line of the lower control device for which startup is instructed by the network management message, and to set the lower control device for which the startup is instructed to be in a startup state, and an abnormality location determination unit configured to detect a power supply state to the lower control devices and a communication state with the lower control devices and to determine an abnormality occurrence location based on a detection result.

### BRIEF DESCRIPTION OF THE DRAWINGS

Objects, features and advantages of the present disclosure will become more apparent from the following detailed description made with reference to the accompanying drawings. In the drawings:

FIG. 1 is a configuration diagram illustrating an example of the configuration of the in-vehicle network system according to the embodiment;

FIG. 2 is an explanatory diagram for explaining an example of the NM message, PN request information, and PNC configuration information;

FIG. 3 is a diagram showing an example of the PNC configuration table stored in the storage unit of the power/startup management ECU;

FIG. 4 is a diagram showing an example of the relay connection information stored in the storage unit of the power/startup management ECU;

FIG. 5 is a configuration diagram illustrating an example of the configuration of the current detection unit provided in the abnormality location determination unit for detecting the power supply state to the lower ECU;

FIG. 6 is a diagram showing the first threshold and the second threshold compared with the detected current amount in the abnormality location determination unit;

FIG. 7 is a flowchart illustrating an example of the process executed in the power/startup management ECU;

FIG. 8 is a flowchart showing the details of the startup ECU identification process in the flowchart of FIG. 7; and

FIG. 9 is a flowchart showing the details of the abnormality location determination process in the flowchart of FIG. 7.

### DETAILED DESCRIPTION

In an in-vehicle network system as described in the related art, it is conceivable that some abnormality may occur, resulting in a communication disruption with the lower control device despite the intermediate control device supplying power to the lower control device. In such cases, the intermediate control device may detect that a communication abnormality has occurred with the lower control device. However, if the specific malfunction causing the communication abnormality is unknown, addressing the issue may become cumbersome, potentially deteriorating maintenance efficiency.

The present disclosure provides an in-vehicle network system that estimates the abnormality occurrence location when an abnormality occurs in the lower control device, and a control method for the in-vehicle network system.

According to an aspect of the present disclosure, an in-vehicle network system that includes a plurality of control devices connected to a communication bus and configured to communicate with each other in a vehicle is provided. The plurality of control devices includes at least one upper control device and a plurality of lower control devices. The at least one upper control device includes a power management unit configured to turn on and off a plurality of relay circuits provided in a power supply line of each of the plurality of the lower control devices, a startup management unit configured to receive a network management message on behalf of a plurality of the lower control devices, the network management message being transmitted via the communication bus and selectively instructs a startup of the plurality of the lower control devices, to instruct the power management unit to turn on the relay circuit provided in the power supply line of the lower control device for which startup is instructed by the network management message, and to set the lower control device for which the startup is instructed to be in a startup state, and an abnormality location determination unit configured to detect a power supply state to the lower control devices and a communication state with the lower control devices and to determine an abnormality occurrence location based on a detection result.

According to an aspect of the present disclosure, a method for controlling an in-vehicle network system including a plurality of control devices connected to a communication bus and configured to communicate with each other in a vehicle is provided. The plurality of control devices includes at least one upper control device and a plurality of lower control devices. The at least one upper control device includes a power management unit configured to turn on and off a plurality of relay circuits provided in a power supply line of each of the plurality of the lower control devices. The method includes: by the at least one upper control device, receiving, on behalf of the plurality of the lower control devices, a network management message that is transmitted via the communication bus and selectively instructs a startup of the plurality of the lower control devices; turning on the relay circuit provided in the power supply line of the lower control device for which startup is instructed by the network management message; setting the lower control device for which the startup is instructed to be in a startup state; detecting a power supply state to the lower control devices and a communication state with the lower control devices; and determining an abnormality occurrence location based on a detection result.

According to the in-vehicle network system and method for controlling the in-vehicle network system of the present disclosure, the upper control device receives the network management message transmitted via the communication bus, which selectively instructs the startup of multiple lower control devices, on behalf of the multiple lower control devices. The upper control device then turns on the relay circuit provided in the power supply line of the lower control device for which startup is indicated by the network management message, thereby activating the instructed lower control device. The upper control device detects the power supply state to the lower control devices and the communication state with the lower control devices, and determines the abnormality occurrence location based on the detection results.

Therefore, according to the in-vehicle network system and control method for the in-vehicle network system of the present disclosure, it is possible to estimate the abnormality occurrence location. Therefore, when an abnormality occurs, it is possible to prevent a decline in the efficiency of maintenance required to resolve the abnormality.

Hereinafter, embodiments of the in-vehicle network system and the control method for the in-vehicle network system according to the present disclosure will be described with reference to the drawings. However, the present disclosure is not limited to the following embodiments, and various modifications described later are also included within the technical scope of the present disclosure. Furthermore, various changes can be made without departing from the spirit of the present disclosure. The embodiments and various modifications can be appropriately combined as long as no technical contradictions arise. In the following description, the same or similar configurations may be assigned the same reference numbers across multiple drawings, and explanations may be omitted. When only part of a configuration is mentioned, the description of other parts can be applied from other sections.

### First Embodiment

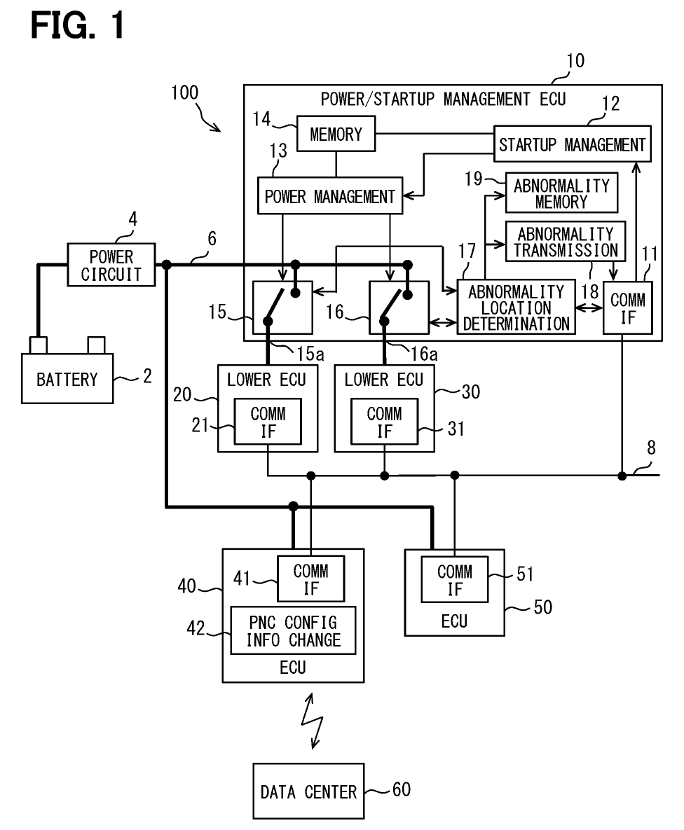

FIG. 1 is a configuration diagram illustrating an example of the configuration of the in-vehicle network system 100 according to this embodiment. As shown in FIG. 1, the in-vehicle network system 100 includes a power/startup management ECU 10 as an upper control device, first and second lower ECUs 20, 30 and first and second normal ECUs 40, 50 as lower control devices. ECU stands for Electronic Control Unit. The first and second lower ECUs 20, 30 are each connected to the power/startup management ECU 10 via first and second relay circuits 15, 16.

The number of first and second lower ECUs 20, 30 connected to the power/startup management ECU 10 via relay circuits such as the first and second relay circuits 15, 16 is not limited to two and may be three or more. Additionally, the number of first and second lower ECUs 20, 30 connected to each of the first and second relay circuits 15, 16 is not limited to one and may be two or more. Furthermore, in the in-vehicle network system 100, the combination of the power/startup management ECU 10 and the first and second lower ECUs 20, 30 is not limited to one set and may be provided in multiple sets. When multiple sets of combinations of the power/startup management ECU 10 and the first and second lower ECUs 20, 30 are provided in the in-vehicle network system 100, each power/startup management ECU 10 and the first and second lower ECUs 20, 30 can be connected for mutual communication via the communication bus 8.

The power/startup management ECU 10, the first and second lower ECUs 20, 30 and the first and second normal ECUs 40, 50 can each be configured by a computer including a processor, a memory, and a storage. The power/startup management ECU 10, the first and second lower ECUs 20, 30 and the first and second normal ECUs 40, 50 also include communication interfaces (IFs) 11, 21, 31, 41, 51 for communicating with other ECUs.

The processor may be, for example, a CPU, MPU, GPU, DFP, or the like that executes predetermined processing according to a program. The memory is a volatile storage medium, such as RAM, that temporarily stores calculation results of the processor. The storage is a non-volatile storage medium, such as flash memory or ROM. Various programs and data executed by the processor are stored in the storage. Some or all of the functions provided by the power/startup management ECU 10, the first and second lower ECUs 20, 30 and the first and second normal ECUs 40, 50 may be realized by hardware using, for example, an ASIC (Application Specific Integrated Circuit) or FPGA (Field-Programmable Gate Array) instead of software such as a program.

The power/startup management ECU 10 can function as a domain controller that oversees the control of the first and second lower ECUs 20, 30. A domain refers to a functional unit when broadly dividing the vehicle's functions, such as the powertrain domain, chassis domain, advanced driver assistance domain, body domain, and cockpit domain. The above is an example of domain division, and the domain division may differ from the examples mentioned above. Additionally, the power/startup management ECU 10 may function as an area controller that oversees the control of the lower ECUs 20, 30 arranged in each area of the vehicle.

The in-vehicle network system 100 can use CAN (registered trademark) as the communication protocol for mutual communication among the ECUs 10, 20, 30, 40, 50. The communication protocol is not limited to CAN, and the in-vehicle network system 100 may adopt another communication protocol, such as CAN-FD. However, in the in-vehicle network system 100 of this embodiment, the first and second lower ECUs 20, 30 and the first and second normal ECUs 40, 50 are divided into multiple groups (referred to as clusters) for each ECU that needs to be activated simultaneously to realize at least one desired function. Using a network management message (referred to as an NM message), the normal operation mode (startup state) and power-saving mode (e.g., sleep state) are switched for each cluster. The power-saving mode includes the power-off state of the first and second lower ECUs 20, 30. Therefore, the communication protocol adopted by the in-vehicle network system 100 needs to support the transmission and reception of NM messages.

The first and second lower ECUs 20, 30 and the first and second normal ECUs 40, 50 are, for example, control ECUs for controlling a predetermined control target in the vehicle or sensor ECUs for calculating a predetermined physical quantity based on detection signals detected by sensors. The first and second lower ECUs 20, 30 and the first and second normal ECUs 40, 50 enter the startup state in the normal operation mode and perform normal operations when it is necessary to control the control target or calculate a predetermined physical quantity based on the detection signal of sensors. On the other hand, when it is not necessary to control the control target or calculate a predetermined physical quantity, the first and second lower ECUs 20, 30 and the first and second normal ECUs 40, 50 enter a power-off state or sleep state in the power-saving mode.

For switching between such a startup state (in a normal operation mode) and a power-off state or a sleep state (in a power-saving mode), the first and second lower ECUs 20, 30 and the first and second normal ECUs 40, 50 are each assigned to a cluster within the multiple divided clusters. The assigned cluster is retained by each ECU as cluster configuration information (also referred to as PNC configuration information). However, the PNC configuration information of the first and second lower ECUs 20, 30 is stored in the storage unit 14 of the power/startup management ECU 10, as described later. Then, in response to the startup cluster information (also referred to as PN request information) included in the NM message, the first and second lower ECUs 20, 30 and the first and second normal ECUs 40, 50 are configured to switch from the power-off state or sleep state to the startup state.

When the first and second lower ECUs 20, 30 and the first and second normal ECUs 40, 50 transition to the startup state and enter the normal operation mode, they periodically transmit NM messages to other ECUs while performing their normal operations. Once these ECUs complete the necessary processing and no longer need to execute normal operations, they stop the periodic transmission of NM messages. The first and second normal ECUs 40, 50 transition from the normal operation mode to the power-saving mode, switching from the startup state to the sleep state when they do not receive NM messages from other ECUs belonging to the same cluster for a predetermined standby time. Regarding the first and second lower ECUs 20, 30, the power/startup management ECU 10 monitors a NM message directed to the first and second lower ECUs 20, 30. When the time without receiving the NM message directed to the first and second lower ECUs 20, 30 reaches the predetermined standby time, the power/startup management ECU 10 turns off the first and second relay circuits 15, 16, stopping the power supply to the first and second lower ECUs 20, 30.

The first and second normal ECUs 40, 50 have communication IFs 41, 51 capable of receiving NM messages in the sleep state and switching from the sleep state to the startup state in response to the reception of NM messages. When switched to the startup state by the communication IFs 41, 51, the first and second normal ECUs 40, 50 determine whether their startup is requested based on the PN request information in the NM message and their PNC configuration information. If it is determined that their startup is requested, the first and second normal ECUs 40, 50 continue in the startup state. Conversely, if it is determined that their startup is not requested, the first and second normal ECUs 40, 50 return to the sleep state. The determination based on the PN request information and PNC configuration information may be executed by the communication IFs 41, 51. In this case, if the communication IFs 41, 51 determine that startup is requested based on the PN request information and PNC configuration information, the communication IFs 41, 51 transition the corresponding first and second normal ECUs 40, 50 from the sleep state to the startup state. Below, an example of NM messages, PN request information, and PNC configuration information will be explained in detail.

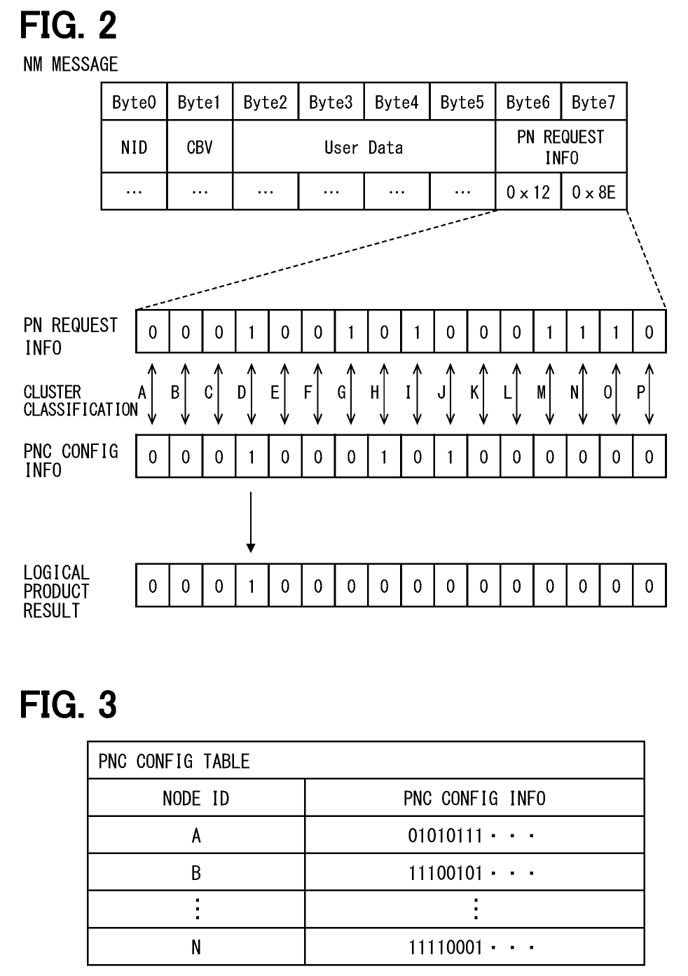

As shown in FIG. 2, NM messages include data from byte 0 to byte 7. Byte 0 contains the node ID (NID) as data. The node ID is a unique identifier for each of the power/startup management ECU 10, the first and second lower ECUs 20, 30 and the first and second normal ECUs 40, 50. The node ID allows identification of the sender of the NM message. Byte 1 contains the control bit vector (CBV) as data. The control bit vector indicates whether partial networking (PN) is used. If the control bit vector indicates the use of partial networking, the user data area from byte 2 to byte 7 contains PN request information, which is startup cluster information indicating the cluster to be activated. Partial networking means activating only the ECUs belonging to certain clusters while keeping the ECUs belonging to other clusters in the power-off state or sleep state. By activating only the ECUs necessary for operation, the power consumption by each ECU installed in the vehicle can be reduced.

In the example shown in FIG. 2, the control bit vector indicates the use of partial networking, and PN request information is stored in bytes 6 and 7 of the user data area. The user data area from byte 2 to byte 5 can be used to transmit arbitrary information, such as ECU startup factors or information regarding normal or abnormal conditions. FIG. 2 merely shows an example of the format of NM messages, and NM messages may take other formats as long as they include the use of partial networking and PN request information.

The PN request information indicates the startup cluster to be activated and the cluster that does not need startup for each of the multiple divided clusters. More specifically, in the example shown in FIG. 2, the clusters are pre-divided into 16. The PN request information includes 16-bit data corresponding to the 16 divided clusters. That is, the 16-bit data of the PN request information is pre-associated with the 16 divided clusters. Each data bit of the 16-bit PN request information indicates that startup of the associated cluster is unnecessary when it is "0" and necessary when it is "1."

As described above, the first and second lower ECUs 20, 30 and the first and second normal ECUs 40, 50 have PNC configuration information indicating the cluster to which they belong among the multiple divided clusters. An example of this PNC configuration information is shown in FIG. 2. FIG. 2 illustrates an example of the PNC configuration information for any one of the first and second lower ECUs 20, 30 and the first and second normal ECUs 40, 50. In the PNC configuration information shown in FIG. 2, when the clusters are classified from left to right in the figure as A to P, the PNC configuration information indicates that the ECU holding this PNC configuration information belongs to clusters D, H, and J. Since the first and second lower ECUs 20, 30 and the first and second normal ECUs 40, 50 can exhibit various functions through program execution, they can belong to one or more clusters.

When the first and second normal ECUs 40, 50 receive the NM message containing the PN request information via the communication IFs 41, 51, the first and second normal ECUs 40, 50 compare the PN request information and the PNC configuration information bit by bit, as shown in FIG. 2, and calculate a logical AND (a logical product), for example. In other words, when NM messages are received at their communication IFs 41, 51, the first and second normal ECUs 40, 50 temporarily enter the startup state. Then, the first and second normal ECUs 40, 50 determine whether the cluster requested for startup by the PN request information in the NM message matches the cluster assigned in their PNC configuration information. For example, in the example shown in FIG. 2, the clusters requested for startup by the PN request information are clusters D, G, I, M, N, and O. The clusters indicated by the PNC configuration information, to which the ECU belongs, are clusters D, H, and J. In this case, the cluster requested for startup by the PN request information in the NM message matches the cluster in the PNC configuration information at cluster D. Therefore, as shown in FIG. 2, the result of the logical AND is "1" at cluster D.

If any bit of the logical AND result is "1," the ECU with the PNC configuration information shown in FIG. 2 determines that its startup is requested. Based on this determination result, the ECU with the PNC configuration information shown in FIG. 2 transitions from the sleep state to the startup state and maintains the startup state if already activated. Conversely, if none of the bits of the logical AND result is "1" and all are "0," the ECU with the PNC configuration information shown in FIG. 2 determines that its startup is not requested. In this case, the ECU with the PNC configuration information shown in FIG. 2 discards the received NM message and returns to the sleep state.

Thus, the first and second normal ECUs 40, 50 have the function to identify whether the NM message requests their startup based on the PNC configuration information. This function to identify NM messages ensures that only the first and second normal ECUs 40, 50 with PNC configuration information containing the clusters requested for startup by the PN request information enter the startup state due to the NM message. Hereinafter, a communication IF equipped with the function to receive NM messages and switch the ECU from the sleep state to the startup state in the sleep state will be referred to as an NM compatible communication IF.

In the in-vehicle network system 100 according to this embodiment, the first and second lower ECUs 20, 30 do not have NM compatible communication IFs. In other words, the communication IFs 21, 31 of the first and second lower ECUs 20, 30 are both NM non-compatible communication IFs. As described above, NM compatible communication IFs have the function to receive NM messages and switch the ECU from the sleep state to the startup state in the sleep state. Therefore, NM compatible communication IFs are more expensive compared to NM non-compatible communication IFs. The communication IFs 21, 31 of the first and second lower ECUs 20, 30 are NM non-compatible communication IFs, as described above. Consequently, by using the combination of the power/startup management ECU 10 and the lower ECUs 20, 30, the overall cost of the in-vehicle network system 100 can be reduced.

In the in-vehicle network system 100 according to this embodiment, despite the communication IFs 21, 31 of the first and second lower ECUs 20, 30 being NM non-compatible communication IFs, the power/startup management ECU 10 is configured to make the first and second lower ECUs 20, 30 subject to partial networking according to NM messages. Furthermore, the power/startup management ECU 10 is configured to determine the location where the abnormality has occurred when some abnormality occurs in at least one of the first and second lower ECUs 20, 30, rendering them unable to operate normally. Below, the power/startup management ECU 10 according to this embodiment will be described in detail with reference to the drawings.

As shown in FIG. 1, the power/startup management ECU 10 includes a communication IF 11, a startup management unit 12, a power management unit 13, a storage unit 14, first and second relay circuits 15, 16, an abnormality location determination unit 17, an abnormality transmission unit 18, and an abnormality storage unit 19. The startup management unit 12, the power management unit 13, the abnormality location determination unit 17, and the abnormality transmission unit 18 are functional units constructed within the power/startup management ECU 10 through software and/or hardware. The storage unit 14 and the abnormality storage unit 19 can be constituted by the storage of the power/startup management ECU 10. The storage unit 14 and the abnormality storage unit 19 may be provided in separate storage or in the same storage.

The first and second relay circuits 15, 16 of the power/startup management ECU 10 are provided in the power supply line 6 to supply power to the first and second lower ECUs 20, 30, respectively. The power circuit 4 can convert the power supply voltage from the vehicle-mounted battery 2 to the operating voltage of the power/startup management ECU 10, the first and second lower ECUs 20, 30, and the first and second normal ECUs 40, 50 as needed. The voltage from the power circuit 4 is supplied to the power supply line 6.

In the example shown in FIG. 1, the power line of the first lower ECU 20 is connected to the first power port 15a connected to the first relay circuit 15. Similarly, the power line of the second lower ECU 30 is connected to the second power port 16a connected to the second relay circuit 16. Power is supplied to the first and second lower ECUs 20, 30 through the first and second relay circuits 15, 16 and their respective power lines. Thus, the first and second relay circuits and their respective power lines correspond to the power supply line.

The first and second relay circuits 15, 16 can be configured using semiconductor switches such as MOSFETs or IGBTs. However, the first and second relay circuits 15, 16 may also be configured using conventional mechanical relays. Additionally, as shown in FIG. 1, the first and second relay circuits 15, 16 may be provided inside or outside the power/startup management ECU 10.

The communication IF 11 of the power/startup management ECU 10 is an NM compatible communication IF capable of receiving NM messages. The communication IFs 21, 31 of the multiple lower ECUs 20, 30 are NM non-compatible communication IFs, as described above. In this embodiment, the multiple lower ECUs 20, 30 enter a power-off state in the power-saving mode when operation is unnecessary. Therefore, the communication IFs 21, 31 of the multiple lower ECUs 20, 30 cannot receive NM messages when the corresponding lower ECUs 20, 30 are in the power-saving mode. Consequently, the communication IF 11 of the power/startup management ECU 10 receives NM messages that selectively instruct the startup of the multiple lower ECUs 20, 30 on behalf of the communication IFs 21, 31 of the multiple lower ECUs 20, 30. The NM messages received by the communication IF 11 are provided to the startup management unit 12.

The storage unit 14 of the power/startup management ECU 10 stores, in addition to programs executed by the processor of the power/startup management ECU 10, the PNC configuration information assigned to each of the first and second lower ECUs 20, 30, indicating the clusters to which each belongs. Furthermore, the storage unit 14 stores relay connection information indicating the correspondence between the first and second relay circuits 15, 16 and the first and second lower ECUs 20, 30.

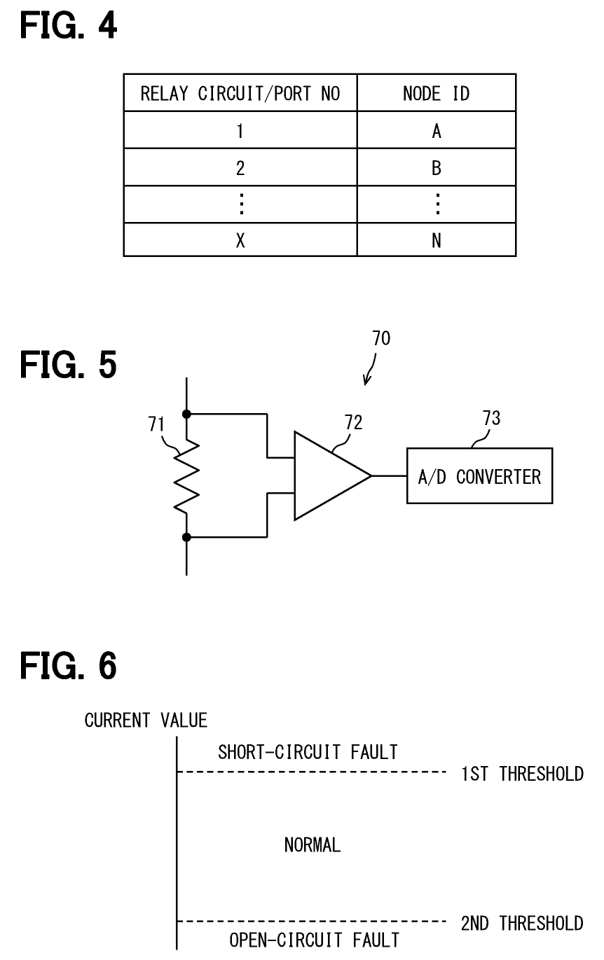

For example, the storage unit 14 can store the PNC configuration information indicating the clusters assigned to each of the first and second lower ECUs 20, 30 using a PNC configuration table as shown in FIG. 3. The PNC configuration table exemplified in FIG. 3 shows the correspondence between the node IDs, which are unique identifiers of multiple lower ECUs including the first and second lower ECUs 20, 30, and the PNC configuration information assigned to the multiple lower ECUs including the first and second lower ECUs 20, 30. Additionally, the storage unit 14 stores relay connection information that indicates the correspondence between the first and second relay circuits 15, 16 and the first and second lower ECUs 20, 30. As exemplified in FIG. 4, the storage unit 14 stores the correspondence between the numbers of multiple relay circuits, including the first and second relay circuits 15, 16, or the numbers of power ports and the node IDs, which are unique identifiers of multiple lower ECUs including the first and second lower ECUs 20, 30.

The startup management unit 12 of the power/startup management ECU 10 can acquire the PNC configuration information of each of the first and second lower ECUs 20, 30 by referring to the PNC configuration table exemplified in FIG. 3. The startup management unit 12 can then determine which of the lower ECUs 20, 30 has been instructed to activate by the NM message based on the acquired PNC configuration information of each lower ECU 20, 30 and the PN request information of the NM message. Specifically, the startup management unit 12 compares the PN request information of the NM message with the PNC configuration information of each of the multiple lower ECUs 20, 30 bit by bit. Based on the comparison result, if the startup management unit 12 determines that there is PNC configuration information containing the cluster requested for startup by the PN request information, it determines that the startup of the lower ECU 20, 30 corresponding to that PNC configuration information has been instructed. In this case, the startup management unit 12 provides the node ID of the lower ECU 20, 30 instructed to activate by the NM message to the power management unit 13. Conversely, if the startup management unit 12 determines that there is no PNC configuration information containing the cluster requested for startup by the PN request information, the received NM message does not instruct the startup of any lower ECU 20, 30, and the NM message is discarded.

Upon receiving the node ID of the lower ECU 20, 30 instructed to activate from the startup management unit 12, the power management unit 13 of the power/startup management ECU 10 refers to the relay connection information stored in the storage unit 14, which indicates the correspondence between each relay circuit 15, 16 and each lower ECU 20, 30. The power management unit 13 then identifies the relay circuits 15, 16 corresponding to the node ID of the lower ECU 20, 30 instructed to activate and outputs a drive signal to turn on the identified relay circuits 15, 16. As a result, power is supplied through the relay circuits 15, 16 corresponding to the lower ECUs 20, 30 instructed to activate, and the corresponding lower ECUs 20, 30 enter the startup state.

The first and second lower ECUs 20, 30 control control target devices among various control target devices mounted on the vehicle, which are controlled only when specific conditions are met or in specific environments (e.g., door lock mechanisms, power window drive motors, headlight light sources, wiper motors, AV equipment), or calculate predetermined physical quantities necessary for the control based on detection signals from sensors. For example, the door lock mechanism is controlled by the door lock control ECU when the vehicle user attempts to enter or exit the vehicle. The power window drive motor is controlled by the power window control ECU when the window lift switch is operated by the user.

Thus, the first and second lower ECUs 20, 30 control control target devices that operate only when specific conditions are met or in specific environments, or calculate predetermined physical quantities necessary for the control. Therefore, when the startup of the first and second lower ECUs 20, 30 is instructed by the NM message, the power/startup management ECU 10 turns on the first and second relay circuits 15, 16 corresponding to the first and second lower ECUs 20, 30, supplying power to the first and second lower ECUs 20, 30. Conversely, when the startup of the first and second lower ECUs 20, 30 is not instructed by the NM message, the power/startup management ECU 10 turns off the first and second relay circuits 15, 16 corresponding to the first and second lower ECUs 20, 30, stopping the power supply to the first and second lower ECUs 20, 30. This allows for cutting off the dark current when the operation of each lower ECU 20, 30 is unnecessary, enabling further power savings for the entire in-vehicle system.

The NM messages can be generated by the power/startup management ECU 10 as a function of a domain controller or area controller. In this case, the power/startup management ECU 10 determines the functions to be executed in the vehicle. When the execution of a desired function is necessary, the power/startup management ECU 10 identifies the cluster that needs to be simultaneously activated to execute the corresponding function and generates an NM message containing PN request information designating the startup cluster. The generated NM message is transmitted via the communication bus 8 to the first and second normal ECUs 40, 50 and other power/startup management ECUs 10. Furthermore, the generated NM message is also used to determine whether it is necessary to switch the lower ECUs 20, 30 of the power/startup management ECU 10 itself to a startup state. However, the function of determining the functions to be executed in the vehicle and transmitting NM messages containing PN request information may be possessed by other ECUs, such as the first and second normal ECUs 40, 50, instead of the power/startup management ECU 10.

Furthermore, the power/startup management ECU 10 may enter the sleep state when all ECUs belonging to the in-vehicle network system 100 are in the sleep state or power-off state and the time without receiving NM messages reaches a predetermined duration.

The abnormality location determination unit 17 of the power/startup management ECU 10 detects the power supply state to the lower ECUs 20, 30 and the communication state with the lower ECUs 20, 30 for the lower ECUs 20, 30 whose relay circuits 15, 16 have been turned on, and determines the abnormality occurrence location based on the detection results. The abnormality location determination unit 17 includes a current detection unit 70, as shown in FIG. 5, to detect the power supply state to the lower ECUs 20, 30. The current detection unit 70 is individually provided for each of the multiple relay circuits 15, 16. The current detection unit 70 includes a shunt resistor 71, a differential amplifier 72, and an A/D converter (Analog-to-Digital Converter) 73.

The shunt resistor 71 is connected upstream and downstream of each relay circuit 15, 16 in the power supply line 6 branched from the common power supply line 6 toward each lower ECU 20, 30. Alternatively, the shunt resistor 71 may be connected within each relay circuit 15, 16 to the power supply line 6. When the corresponding relay circuit 15, 16 is turned on and power is supplied to the lower ECUs 20, 30, a current flows through the shunt resistor 71 corresponding to the power supplied to the lower ECUs 20, 30. As a result, a potential difference occurs across the shunt resistor 71 according to the magnitude of the current flowing through it.

The differential amplifier 72 amplifies and outputs the potential difference across the shunt resistor 71. The A/D converter 73 converts the amplified potential difference from an analog value to a digital value. The digital value represents the current amount flowing through the power supply line 6 to the lower ECUs 20, 30. Therefore, the current detection unit 70 can detect the current amount flowing through the power supply line 6 to the lower ECUs 20, 30 as the power supply state when the relay circuits 15, 16 are turned on and power is supplied to the lower ECUs 20, 30.

The abnormality location determination unit 17 compares the detected current amount with the first threshold for determining a short-circuit fault and the second threshold for determining an open-circuit fault, as shown in FIG. 6. If the detected current amount is greater than the first threshold, the abnormality location determination unit 17 can determine that a short-circuit fault has occurred in the power supply line 6 to the lower ECUs 20, 30. If the detected current amount is less than the second threshold, the abnormality location determination unit 17 can determine that an open-circuit fault has occurred in the power supply line 6 to the lower ECUs 20, 30.

The abnormality location determination unit 17 may determine that the detected current amount is less than the second threshold based on multiple determination results rather than a single determination result when the detected current amount is less than the second threshold. This is because there is a possibility of incorrectly determining the relationship with the second threshold when the detected current amount is small. In this case, the abnormality location determination unit 17 repeats the comparison between the detected current amount and the second threshold a predetermined number of times. If the result that the detected current amount is less than the second threshold is obtained in multiple comparison results, the abnormality location determination unit 17 may determine that an open-circuit fault has occurred in the power supply line 6 to the lower ECUs 20, 30. To ensure accuracy, multiple comparisons with the detected current amount may also be performed for the first threshold. In this case, the abnormality location determination unit 17 repeats the comparison between the detected current amount and the first threshold a predetermined number of times. The predetermined number of times for repeating the comparison with the first threshold and the second threshold may be the same or different.

In addition to or instead of comparing the detected current amount with the second threshold, the abnormality location determination unit 17 may compare the detected current amount with the minimum consumption current value during normal operation of the lower ECUs 20, 30 in the startup state. In this case, if the detected current amount is less than the minimum consumption current value, the abnormality location determination unit 17 may determine that an abnormality has occurred in the power supply line 6 to the lower ECUs 20, 30 and/or the lower ECUs 20, 30.

If the comparison results between the detected current amount and the first threshold, second threshold, and/or minimum consumption current value indicate that an abnormality has occurred in the power supply line 6 to the lower ECUs 20, 30, the abnormality location determination unit 17 outputs a drive signal to turn off the corresponding relay circuits 15, 16. As a result, the relay circuits 15, 16 provided in the power supply line 6 where the abnormality occurred are switched from on to off. Consequently, the power supply to the lower ECUs 20, 30, which are expected to not operate normally due to the abnormality, can be cut off.

Additionally, to detect the communication state with the lower ECUs 20, 30, the abnormality location determination unit 17 sends messages to the lower ECUs 20, 30 whose relay circuits 15, 16 have been turned on via the communication IF 11 and the communication bus 8. The abnormality location determination unit 17 then detects the presence or absence of responses from the lower ECUs 20, 30 to the sent messages. In other words, the abnormality location determination unit 17 detects the presence or absence of responses to the messages sent to the lower ECUs 20, 30 as the communication state with the lower ECUs 20, 30. The transmission of messages and detection of responses are executed individually for each of the multiple lower ECUs 20, 30.

If there is a response from the lower ECUs 20, 30, the abnormality location determination unit 17 can consider the communication state with the lower ECUs 20, 30 to be normal. Conversely, if there is no response from the lower ECUs 20, 30, the abnormality location determination unit 17 can consider the communication state with the lower ECUs 20, 30 to be abnormal. More specifically, if the power supply state to the lower ECUs 20, 30 is normal but no response is obtained from the lower ECUs 20, 30 to the messages, the abnormality location determination unit 17 can determine that an abnormality has occurred in the communication bus 8, the communication IFs 21, 31, and/or the lower ECUs 20, 30.

If an abnormality occurs in the communication bus 8, the communication IFs 21, 31, and/or the lower ECUs 20, 30, the abnormality location determination unit 17 may turn off the corresponding relay circuits 15, 16 and then turn them on again. This allows the corresponding lower ECUs 20, 30 to be restarted. The restart may restore the lower ECUs 20, 30 to a normal state. If the abnormality location determination unit 17 attempts recovery from the abnormality a predetermined number of times but still does not receive a response from the lower ECUs 20, 30 to the messages, it may determine that an abnormality has occurred in the communication bus 8, communication IFs 21, 31, and/or the lower ECUs 20, 30. The abnormality in the communication IFs 21, 31 of the lower ECUs 20, 30 can be considered an abnormality of the lower ECUs 20, 30.

If an abnormality is determined to have occurred in the communication bus 8, the communication IFs 21, 31, and/or the lower ECUs 20, 30, the abnormality location determination unit 17 outputs a drive signal to turn off the corresponding relay circuits 15, 16. This switches the relay circuits 15, 16 corresponding to the lower ECUs 20, 30 where the abnormality occurred from on to off, thereby cutting off the power supply to the lower ECUs 20, 30 that are expected not to operate normally due to the abnormality.

The abnormality transmission unit 18 of the power/startup management ECU 10 creates an abnormality notification message containing the node ID of the affected lower ECUs 20, 30 and/or information indicating the cluster to which the corresponding lower ECUs 20, 30 belong when the abnormality location determination unit 17 determines the abnormality occurrence location. The abnormality transmission unit 18 sends the created abnormality notification message to other ECUs in the in-vehicle network system 100 (e.g., the first and second normal ECUs 40, 50) via the communication IF 11 and the communication bus 8. This allows other ECUs in the in-vehicle network system 100 to understand the cause of communication disruption with the lower ECUs 20, 30.

The abnormality storage unit 19 of the power/startup management ECU 10 stores information indicating the abnormality occurrence location when the abnormality location determination unit 17 determines the abnormality occurrence location. For example, if the abnormality location determination unit 17 determines that an abnormality has occurred in the power supply line 6 of the first lower ECU 20, the abnormality storage unit 19 stores the power supply line 6 of the first lower ECU 20 as the abnormality occurrence location. The abnormality occurrence location stored in the abnormality storage unit 19 can be read by a diagnostic tool connected to the communication bus 8 via a data link coupler or by a data center 60 serving as a diagnostic tool. This allows maintenance personnel to obtain information about the abnormality occurrence location (corresponding the location where the abnormality has occurred) and smoothly perform measures to resolve the abnormality.

The power/startup management ECU 10 may not have the abnormality storage unit 19. For example, the abnormality location determination unit 17 can be configured to send information indicating the abnormality occurrence location to an external server such as a data center 60 each time it determines the abnormality occurrence location. In this case, maintenance personnel can obtain information about the abnormality occurrence location from the data center 60.

In the in-vehicle network system 100 according to this embodiment, any ECU belonging to the in-vehicle network system 100, such as the power/startup management ECU 10, the first and second normal ECUs 40, 50, may implement a PNC configuration information modification unit 42 to modify the PNC configuration information held by each ECU 10, 40, 50. FIG. 1 shows an example where the PNC configuration information modification unit 42 is implemented in the first normal ECU 40.

The first normal ECU 40, which has the PNC configuration information modification unit 42 implemented, includes an external communication device capable of wireless communication with external servers such as the data center 60. The first normal ECU 40 is configured to download application programs for implementing new functions in the vehicle or update programs for upgrading the version of programs already implemented in any ECU 10, 20, 30, 40, 50 via the external communication device. The downloaded programs are provided to the relevant ECUs 10, 20, 30, 40, 50 via the communication bus 8, and the installation of new application programs or rewriting to update programs is executed. The ECU communicating with external servers via the external communication device and the ECU implementing the PNC configuration information modification unit 42 may be separate ECUs.

Here, regarding the ECUs 10, 20, 30, 40, 50 where new application programs or update programs are implemented, it may be necessary to add or change the startup conditions of the relevant ECUs depending on the functions of the application programs or update programs. Therefore, when it is necessary to add or change the startup conditions of the ECU where the application program or update program is implemented, the data center 60 downloads new PNC configuration information corresponding to the addition or change of startup conditions to the first normal ECU 40 along with the application program or update program.

When the PNC configuration information modification unit 42 acquires new PNC configuration information from the data center 60, it changes (rewrites) the PNC configuration information held by the ECUs 10, 20, 30, 40, 50 where the application program or update program is implemented to the new PNC configuration information. This allows the ECUs 10, 20, 30, 40, 50 where the application program or update program is implemented to switch from the sleep state (including the power-off state) to the startup state according to the cluster indicated by the modified PNC configuration information. The rewriting of PNC configuration information may be executed by the relevant ECU upon receiving a rewrite instruction along with the new PNC configuration information from the PNC configuration information modification unit 42. Alternatively, the rewriting of PNC configuration information may be executed by the PNC configuration information modification unit 42 by accessing the memory of the relevant ECU.

The PNC configuration information modification unit 42 can be provided outside the in-vehicle network system 100, such as in a data center 60, instead of being part of an ECU belonging to the in-vehicle network system 100. However, if the PNC configuration information modification unit 42 is implemented in an ECU belonging to the in-vehicle network system 100, communication with external entities can be terminated once the data for modifying the PNC configuration information of the ECU is acquired from outside. On the other hand, if the PNC configuration information modification unit 42 is provided in an external server outside the in-vehicle network system 100, the ECU requiring PNC configuration information modification must individually communicate with the external server via an ECU equipped with an external communication device. This may result in the disadvantage of increased communication volume with external servers.

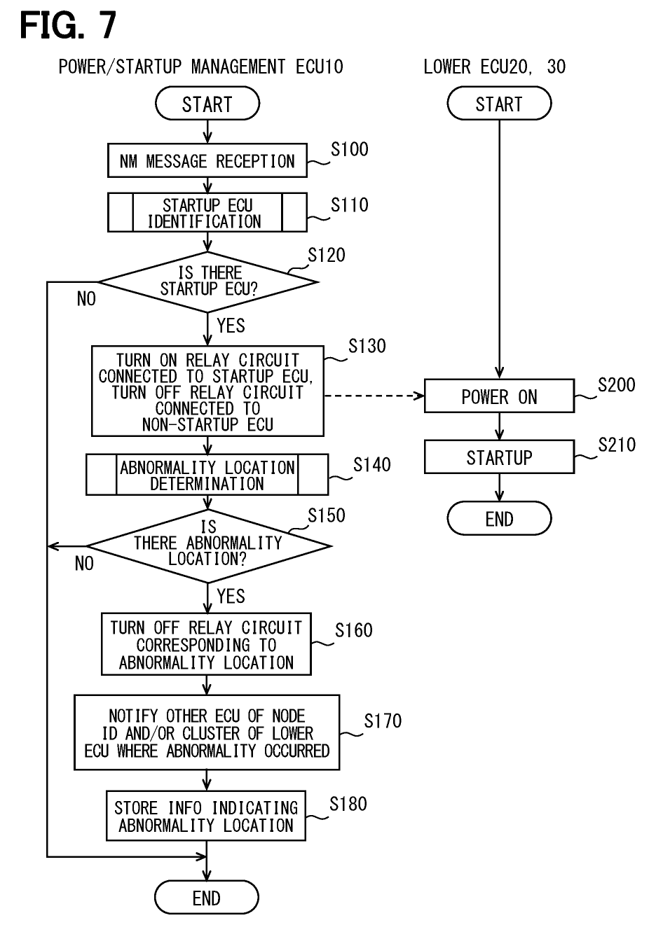

An example of the processing executed by the power/startup management ECU 10 will be described with reference to the flowcharts in FIG. 7 to FIG. 9. The processing executed by the power/startup management ECU 10 includes processing to make the first and second lower ECUs 20, 30 subject to partial networking according to NM messages. Additionally, the processing executed by the power/startup management ECU 10 includes determining the abnormality occurrence location based on the power supply state to the first and second lower ECUs 20, 30 and the communication state with the lower ECUs 20, 30, and addressing the abnormality occurrence location if present. The execution of the processing shown in the flowcharts of FIG. 7 to FIG. 9 by the power/startup management ECU 10 corresponds to executing the control method of the in-vehicle network system 100 disclosed herein.

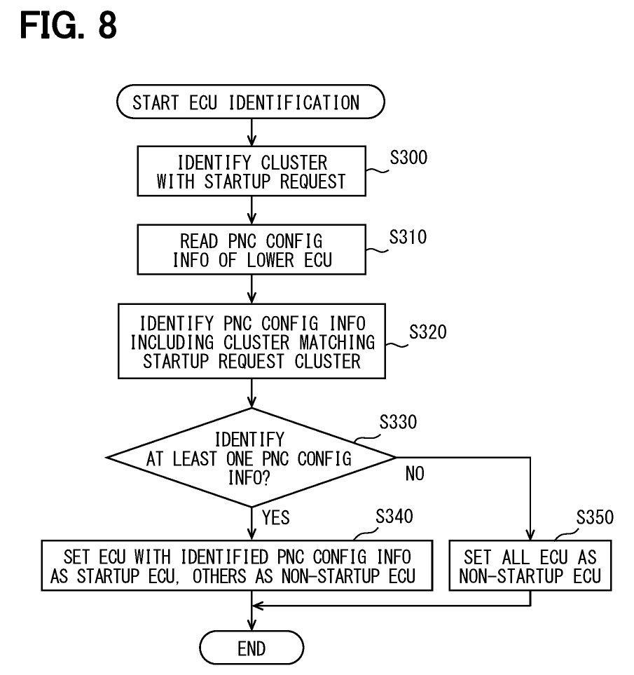

In step S100, the power/startup management ECU 10 receives an NM message. In step S110, the power/startup management ECU 10 executes a startup ECU identification process to identify the lower ECUs 20, 30 instructed to activate by the NM message. The details of this startup ECU identification process are shown in the flowchart of FIG. 8. Below, the startup ECU identification process will be described with reference to the flowchart in FIG. 8.

In step S300, the power/startup management ECU 10 identifies the cluster requested for startup based on the PN request information in the NM message. In step S310, the power/startup management ECU 10 reads the PNC configuration information of the multiple lower ECUs 20, 30 from the storage unit 14. Then, in step S320, the power/startup management ECU 10 identifies the PNC configuration information containing the cluster matching the cluster (startup request cluster) for which startup is requested by the PN request information.

In step S330, the power/startup management ECU 10 determines whether at least one PNC configuration information among the PNC configuration information of the multiple lower ECUs 20, 30 has been identified as containing a cluster matching the startup request cluster. If at least one PNC configuration information is identified, the power/startup management ECU 10 proceeds to the processing of step S340. Conversely, if no PNC configuration information is identified, the power/startup management ECU 10 proceeds to the processing of step S350.

In step S340, the power/startup management ECU 10 sets the lower ECUs 20, 30 corresponding to the identified PNC configuration information as startup ECUs and sets the other lower ECUs 20, 30 as non-startup ECUs. In step S350, the power/startup management ECU 10 sets all lower ECUs 20, 30 as non-startup ECUs. Afterward, the power/startup management ECU 10 returns to the processing shown in the flowchart of FIG. 7.

In step S120 of the flowchart in FIG. 7, the power/startup management ECU 10 determines whether there are lower ECUs 20, 30 set as startup ECUs. If there are lower ECUs 20, 30 set as startup ECUs, the power/startup management ECU 10 proceeds to the processing of step S130. Conversely, if there are no lower ECUs 20, 30 set as startup ECUs, the power/startup management ECU 10 terminates the processing shown in the flowchart of FIG. 7. In this case, the NM message is discarded.

In step S130, the power/startup management ECU 10 turns on the relay circuits 15, 16 connected to the lower ECUs 20, 30 set as startup ECUs based on the relay connection information stored in the storage unit 14, which indicates the correspondence between each relay circuit 15, 16 and each lower ECU 20, 30. Additionally, the power/startup management ECU 10 turns off the relay circuits 15, 16 connected to the lower ECUs 20, 30 set as non-startup ECUs.

As shown in step S200 of the flowchart in FIG. 7, power supply is initiated for the lower ECUs 20, 30 whose relay circuits 15, 16 have been turned on. Consequently, in step S210, the lower ECUs 20, 30 whose relay circuits 15, 16 have been turned on undergo predetermined processing for startup and enter the startup state.

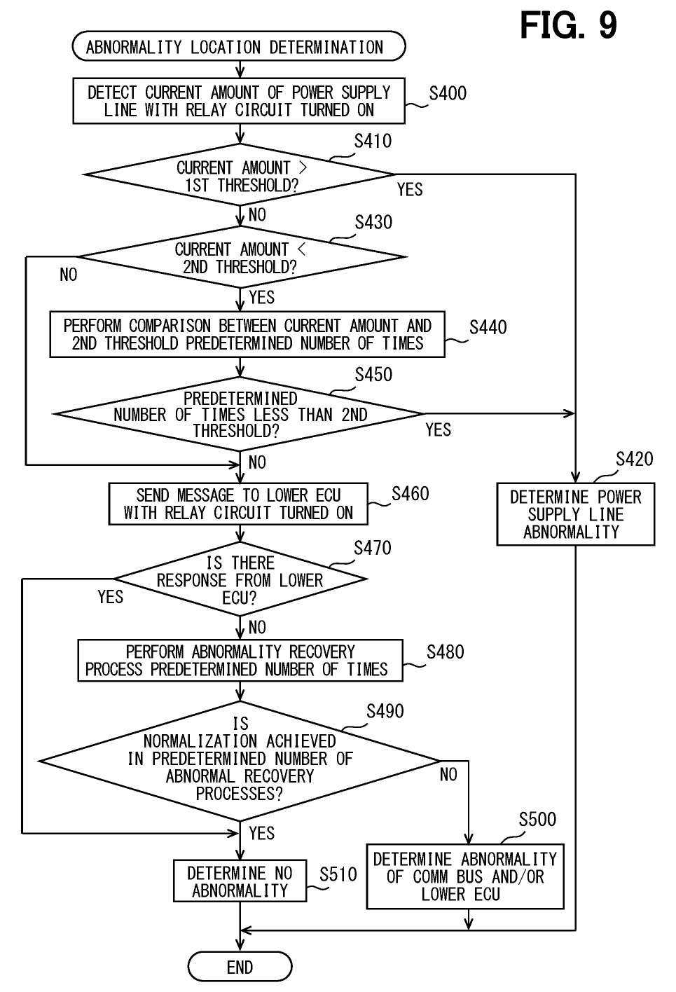

In step S140, the power/startup management ECU 10 executes an abnormality location determination process to determine the abnormality occurrence location based on the power supply state to the lower ECUs 20, 30 whose relay circuits 15, 16 have been turned on and the communication state with the lower ECUs 20, 30. The details of this abnormality location determination process are shown in the flowchart of FIG. 9. Below, the startup ECU identification process will be described with reference to the flowchart in FIG. 9.

In step S400, the power/startup management ECU 10 detects the current amount flowing through the power supply line 6 to the lower ECUs 20, 30 whose relay circuits 15, 16 have been turned on, as the power supply state to the lower ECUs 20, 30.

In step S410, the power/startup management ECU 10 determines whether the detected current amount is greater than the first threshold for determining a short-circuit fault. If the detected current amount is determined to be greater than the first threshold, the power/startup management ECU 10 proceeds to the processing of step S420. In step S420, the power/startup management ECU 10 determines that an abnormality has occurred in the power supply line 6 to the lower ECUs 20, 30 whose relay circuits 15, 16 have been turned on, as the abnormality occurrence location. Conversely, if the detected current amount is determined to be less than or equal to the first threshold, the power/startup management ECU 10 proceeds to the processing of step S430.

In step S430, the power/startup management ECU 10 determines whether the detected current amount is less than the second threshold for determining an open-circuit fault. If the detected current amount is determined to be less than the second threshold, the power/startup management ECU 10 proceeds to the processing of step S440. Conversely, if the detected current amount is determined to be equal to or greater than the second threshold, the power/startup management ECU 10 proceeds to the processing of step S460.

In step S440, the power/startup management ECU 10 repeats the comparison between the detected current amount and the second threshold a predetermined number of times. In step S450, if the result that the detected current amount is less than the second threshold is obtained in the predetermined number of comparisons, the power/startup management ECU 10 proceeds to the processing of step S420. In step S420, the power/startup management ECU 10 determines that an abnormality has occurred in the power supply line 6 to the lower ECUs 20, 30 whose relay circuits 15, 16 have been turned on. Conversely, if the result that the detected current amount is less than the second threshold is not obtained in the predetermined number of comparisons, the power/startup management ECU 10 proceeds to the processing of step S460.

In step S460, the power/startup management ECU 10 sends a message to the lower ECUs 20, 30 whose relay circuits 15, 16 have been turned on to detect the communication state with the lower ECUs 20, 30. In step S470, the power/startup management ECU 10 determines whether a response to the sent message is detected from the lower ECUs 20, 30. If a response is detected, the power/startup management ECU 10 proceeds to the processing of step S510. Conversely, if a response is not detected, the power/startup management ECU 10 proceeds to the processing of step S480.

In step S480, the power/startup management ECU 10 executes an abnormal recovery process by turning off the relay circuits 15, 16 corresponding to the lower ECUs 20, 30 where a response is not detected, up to a predetermined number of times, and then turning the relay circuits 15, 16 on to restart the lower ECUs 20, 30. In step S490, the power/startup management ECU 10 determines whether a response to the message is detected from the restarted lower ECUs 20, 30 within the execution of the abnormal recovery process a predetermined number of times, in other words, whether the lower ECUs 20, 30 have normalized. If it is determined that the lower ECUs 20, 30 have not normalized, the power/startup management ECU 10 proceeds to the processing of step S500. Conversely, if it is determined that the lower ECUs 20, 30 have normalized, the power/startup management ECU 10 proceeds to the processing of step S510.

In step S500, the power/startup management ECU 10 determines that an abnormality has occurred in the communication bus 8 and/or the lower ECUs 20, 30 where a response to the message is not detected, as the abnormality occurrence location. In step S510, the power/startup management ECU 10 determines that no abnormality has occurred in the power supply line 6 and communication bus 8 to the lower ECUs 20, 30.

In step S150 of the flowchart in FIG. 7, the power/startup management ECU 10 determines whether the abnormality occurrence location has been identified in the abnormality location determination process of step S140. If it is determined that the abnormality occurrence location has been identified, the power/startup management ECU 10 proceeds to the processing of step S160. Conversely, if it is determined that no abnormality occurrence location has been identified, the power/startup management ECU 10 terminates the processing shown in the flowchart of FIG. 7.

In step S160, the relay circuits 15, 16 corresponding to the abnormality occurrence location are turned off. This allows the power supply to be cut off to the lower ECUs 20, 30, which are expected not to operate normally where an abnormality has occurred in the power supply line 6, the communication bus 8, and/or the lower ECUs 20, 30.

In step S170, the power/startup management ECU 10 creates an abnormality notification message containing information indicating the node ID of the lower ECUs 20, 30 corresponding to the abnormality occurrence location and/or the cluster to which the lower ECUs 20, 30 belong. The power/startup management ECU 10 then transmits the created abnormality notification message to other ECUs in the in-vehicle network system 100. This allows other ECUs in the in-vehicle network system 100 to understand the cause of communication disruption with the lower ECUs 20, 30.

In step S180, the power/startup management ECU 10 stores information indicating the abnormality occurrence location. The stored abnormality occurrence location can be read by a diagnostic tool connected to the communication bus 8 via a data link coupler or by a data center 60 serving as a diagnostic tool.

As described above, according to the in-vehicle network system 100 of this embodiment, the power/startup management ECU 10 receives NM messages that selectively instruct the startup of multiple lower ECUs 20, 30, which are transmitted via the communication bus 8, on behalf of the multiple lower ECUs 20, 30. The power/startup management ECU 10 then turns on the relay circuits 15, 16 connected to the lower ECUs 20, 30 instructed to activate by the NM messages. This allows the lower ECUs 20, 30 instructed to activate to enter the startup state. Therefore, according to the in-vehicle network system 100 of this embodiment, it is possible to finely manage the supply and stoppage of power to the lower ECUs 20, 30 while configuring the system to switch the power to the lower ECUs 20, 30 from a stopped state to a supply state in response to NM messages instructing startup.

Furthermore, according to the in-vehicle network system 100 of this embodiment, the power supply state to the lower ECUs 20, 30 whose relay circuits 15, 16 have been turned on, and the communication state with the lower ECUs 20, 30 are detected, and the abnormality occurrence location is determined based on the detection results. Therefore, according to the in-vehicle network system 100 of this embodiment, since it is possible to determine the abnormality occurrence location, it is possible to suppress the deterioration of maintenance efficiency when an abnormality occurs, thereby facilitating the resolution of the abnormality.

### Modifications

While the preferred embodiment of the present disclosure has been described above, the present disclosure is not limited to the aforementioned embodiment and can be variously modified and implemented without departing from the spirit of the present disclosure.

For example, in the aforementioned embodiment, an example was described where the power supply state to the lower ECUs 20, 30 whose relay circuits 15, 16 have been turned on, and the communication state with the lower ECUs 20, 30 are detected, and the abnormality occurrence location is determined based on the detection results. In addition to this, it is also possible to detect the power supply state to the lower ECUs 20, 30 whose relay circuits 15, 16 are turned off, and the communication state with the lower ECUs 20, 30, and determine the abnormality occurrence location based on the detection results. This allows for the detection of abnormalities where a short-circuit fault occurs in the relay circuits 15, 16, resulting in unintended power supply to the lower ECUs 20, 30.

Additionally, in the flowchart of FIG. 9, an example was described where the communication state with the lower ECUs 20, 30 is detected when power is being normally supplied to the lower ECUs 20, 30. However, the communication state with the lower ECUs 20, 30 may be detected regardless of whether power is being normally supplied to the lower ECUs 20, 30.

The systems and methods described in this disclosure may be implemented by a dedicated computer configured with a processor programmed to execute one or more functions embodied in a computer program. The systems and methods described in this disclosure may also be implemented using dedicated hardware logic circuits. Furthermore, the systems and methods described in this disclosure may be implemented by one or more dedicated computers configured with a combination of a processor executing a computer program and one or more hardware logic circuits. For example, some or all of the functions provided by the power/startup management ECU 10 may be implemented as hardware. The implementation of certain functions as hardware may include using one or more ICs. Some or all of the functions provided by the power/startup management ECU 10 may be implemented using a System-on-Chip (SoC), Integrated Circuit (IC), or Field-Programmable Gate Array (FPGA). The concept of ICs includes Application Specific Integrated Circuits (ASICs). Additionally, the computer program may be stored as instructions executable by a computer on a non-transitory tangible storage medium. Possible recording media for the program include HDDs (Hard-disk Drives), SSDs (Solid State Drives), flash memory, and the like. Furthermore, a program for making a computer function as the power/startup management ECU 10, and non-transitory tangible storage media such as semiconductor memory recording this program, are also included within the scope of this disclosure.

In the present disclosure, the term "circuit" refers to a single hardware logic circuit or several hardware logic circuits (in other words, "circuitry") that are configured to execute specific processing defined based on a pre-designed circuit configuration. In other words (and in contrast to the "processor"), the term "circuit" in the present disclosure refers to a hardware device that executes specific processing based on a circuit configuration, not processing defined by software such as the above-described computer program code. For instance, "circuit" may include a custom IC (Integrated Circuit) such as ASIC (Application Specific Integrated Circuit) or FPGA (Field Programmable Gate Array) designed using a hardware description language (HDL). That is, the term "circuit" in the present disclosure includes all hardware circuits except the above-described processor that executes processing by reading computer program code.

In the present disclosure, the phrase "at least one of a circuit and a processor" should be interpreted disjunctively (logical OR) and should not be interpreted as at least one circuit and at least one processor. Therefore, in the present disclosure, "at least one of a circuit and a processor is configured to cause a control device to execute functions" includes the case where only the circuit causes the control device to execute all the functions. Additionally, "at least one of a circuit and a processor is configured to cause the control device to execute functions" includes the case where only the processor causes the control device to execute all the functions. Furthermore, "at least one of a circuit and a processor is configured to cause the control device to execute functions" includes the case where the circuit causes the control device to execute some of the functions and the processor causes the control device to execute the remaining functions. In the last case, for instance, if the control device executes functions A to C, functions A and B may be implemented by the circuit, and the remaining function C may be implemented by the processor.

What is claimed is:

1. An in-vehicle network system comprising:
a plurality of control devices connected to a communication bus and configured to communicate with each other in a vehicle,
wherein:
the plurality of control devices includes at least one upper control device and a plurality of lower control devices;
the at least one upper control device includes at least one of (i) a circuit and (ii) a processor with a memory storing computer program code executable by the processor, the at least one of the circuit and the processor configured to cause the upper control device to implement
a power management unit configured to turn on and off a plurality of relay circuits provided in a power supply line of each of the plurality of the lower control devices,
a startup management unit configured to receive a network management message on behalf of a plurality of the lower control devices, wherein the network management message is transmitted via the communication bus and selectively instructs a startup of the plurality of the lower control devices, to instruct the power management unit to turn on the relay circuit provided in the power supply line of the lower control device for which startup is instructed by the network management message, and to set the lower control device for which the startup is instructed to be in a startup state, and
an abnormality location determination unit configured to detect a power supply state to the lower control devices and a communication state with the lower control devices and to determine an abnormality occurrence location based on a detection result.

2. The in-vehicle network system according to claim 1, wherein
the abnormality location determination unit detects the power supply state to the lower control device and the communication state with the lower control device for the lower control device for which the relay circuit has been turned on, and determines the abnormality occurrence location based on the detection result.

3. The in-vehicle network system according to claim 1, wherein
the network management message includes startup cluster information that specifies a startup cluster indicating a group of control devices to be started;
the at least one upper control device further includes a storage unit configured to store cluster configuration information indicating a cluster to which the lower control devices belong for each of the plurality of lower control devices; and
the startup management unit determines that the startup of the lower control devices corresponding to the cluster configuration information is instructed by the network management message when the startup cluster specified by the startup cluster information in the network management message matches the cluster in the cluster configuration information stored in the storage unit.

4. The in-vehicle network system according to claim 3, further comprising
a modification unit configured to change the cluster configuration information of each of the plurality of lower control devices, stored by the at least one upper control device.

5. The in-vehicle network system according to claim 4, wherein
the modification unit is implemented in any of the plurality of control devices connected to the communication bus.

6. The in-vehicle network system according to claim 3, wherein
the at least one upper control device includes a storage unit that stores the cluster configuration information of each of the plurality of lower control devices and relay connection information indicating a correspondence between the plurality of lower control devices and the plurality of relay circuits.

7. The in-vehicle network system according to claim 6, wherein
the at least one upper control device, based on the cluster configuration information and the relay connection information, turns on the relay circuit corresponding to the lower control device of which the cluster of the cluster configuration information matches the startup cluster specified by the startup cluster information included in the network management message and turns off the relay circuit corresponding to the lower control device whose cluster does not match.

8. The in-vehicle network system according to claim 1, wherein
the abnormality location determination unit detects current amount flowing through the power supply line of the lower control device as the power supply state to the lower control device.

9. The in-vehicle network system according to claim 8, wherein
the abnormality location determination unit determines that an abnormality has occurred in the power supply line of the lower control device when the detected current amount is greater than a first threshold for determining a short-circuit fault or when the detected current amount is less than a second threshold for determining an open-circuit fault.

10. The in-vehicle network system according to claim 8, wherein
the abnormality location determination unit repeatedly compares the detected current amount with a first threshold or a second threshold a predetermined number of times when the detected current amount is greater than the first threshold or when the detected current amount is less than the second threshold, and
the abnormality location determination unit determines that the abnormality has occurred in the power supply line of the lower control device when, in results of a plurality of comparisons, it is determined that the current amount is greater than the first threshold or less than the second threshold.

11. The in-vehicle network system according to claim 8, wherein
the abnormality location determination unit determines that an abnormality has occurred in the power supply line of the lower control device and/or the lower control device when the detected current amount is less than a minimum consumption current during normal operation of the lower control device set to a startup state.

12. The in-vehicle network system according to claim 9, wherein
the abnormality location determination unit switches the relay circuit from on to off in response to determining that the abnormality has occurred in the power supply line of the lower control device.

13. The in-vehicle network system according to claim 1, wherein
the abnormality location determination unit, as the communication state with the lower control device, transmits a message to the lower control device via the communication bus and detects a presence or absence of a response to the message.

14. The in-vehicle network system according to claim 13, wherein
the abnormality location determination unit determines that abnormality has occurred in the communication bus with the lower control device and/or in the lower control device when the response to the message is not received from the lower control device despite that the power supply state to the lower control device is normal.

15. The in-vehicle network system according to claim 13, wherein
the abnormality location determination unit attempts to recover from abnormality by turning off the relay circuit and then turning on the relay circuit upon determining that the abnormality has occurred in the communication bus with the lower control device or in the lower control device, and determines that the abnormality has occurred in the communication bus with the lower control device and/or in the lower control device when the response to the message is not received after a predetermined number of times of recovery attempts.

16. The in-vehicle network system according to claim 14, wherein
the abnormality location determination unit turns off the relay circuit in response to determining that the abnormality has occurred in the communication bus with the lower control device and/or in the lower control device.

17. The in-vehicle network system according to claim 1, wherein
the at least one of the circuit and the processor is configured to cause the upper control device to further implement
an abnormality transmission unit configured to create and send an abnormality notification message including information indicating an identifier of the lower control device corresponding to the abnormality occurrence location and/or a cluster to which the corresponding lower control device belongs, to a different control device when the abnormality location determination unit determines the location of abnormality.

18. The in-vehicle network system according to claim 1, wherein
the at least one upper control device further includes an abnormality storage unit configured to store information indicating abnormality occurrence location when the abnormality location determination unit determines the abnormality occurrence location.

19. A method for controlling an in-vehicle network system including a plurality of control devices connected to a communication bus and configured to communicate with each other in a vehicle, wherein the plurality of control devices includes at least one upper control device and a plurality of lower control devices, the at least one upper control device is configured to turn on and off a plurality of relay circuits provided in a power supply line of each of the plurality of the lower control devices, the method comprising:
by the at least one upper control device,
receiving, on behalf of the plurality of the lower control devices, a network management message that is transmitted via the communication bus and selectively instructs a startup of the plurality of the lower control devices;
turning on the relay circuit provided in the power supply line of the lower control device for which startup is instructed by the network management message;
setting the lower control device for which the startup is instructed to be in a startup state;
detecting a power supply state to the lower control devices and a communication state with the lower control devices; and
determining an abnormality occurrence location based on a detection result.
